(19) United States
(12) Patent Application Publication
(10) Pub. No.: US 2005/0062730 A1
(43) Pub. Date: Mar. 24, 2005

(54) Ergonomic pointing device

(76) Inventor: Henryk Birecki, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/665,919

(22) Filed: Sep. 19, 2003

(51) Int. Cl. G09G 5/00

(52) U.S. Cl. 345/179

(57) ABSTRACT

An ergonomic pointing device is disclosed. The ergonomic pointing device includes a holder mounted to a finger on a users hand and a pointing implement mounted to the holder. The user manipulates the ergonomic pointing device to bring the pointing implement into contact with a device to initiate an action in the device. Optionally, a holster can be connected with the holder to mount the pointing implement on the holder. The pointing implement can be movable in the holder and/or the holster. The holster can be removably connected with the holder. The ergonomic pointing device allows a user to interface with a device without having to use the hand to hold a stylus or the like. The holder can be mounted on the finger using an adhesive and portions of the ergonomic pointing device can be disposable while other portions can be recyclable.

### FIELD OF THE INVENTION

The present invention relates generally to an ergonomic pointing device. More specifically, the present invention relates to an ergonomic pointing device that is mounted to a finger of a users hand and allows the user to initiate an action in a device by urging a pointing implement carried by the ergonomic pointing device into contact with the device.

### BACKGROUND OF THE INVENTION

There are many portable devices such as personal digital assistants (PDA's), tablet personal computers (TPC's), cell phones, global positioning receivers (GPS), and devices equipped with touch-sensitive displays that are responsive to a pointing implement (e.g. a stylus) that is manipulated by a hand of a user of the device. Although the pointing implement serves the ergonomic needs of the user for some foreseeable uses of the device, there are some uses for which the pointing implement is not ergonomically efficient.

For example, when a PDA is held in the hand of a user in an environment such as an office, a home, a passenger seat of a car, or an airplane seat, the user can rest his/her arm on a desk, a table, or an arm of a chair or a seat. In those environments, a stylus carried by the PDA can easily be used to initiate actions in the PDA by touching the stylus to a touch-sensitive display of the PDA to drag icons, open and close files, to start or close programs, etc.

On the other hand, when the user is in an environment where his/her body is in motion, is subject to vibration, or the user cannot hold the PDA, then touching the stylus to the touch-sensitive display of the PDA can cause entry errors, especially if the users hand cannot be held steady while trying to initiate an action in the PDA. Moreover, there are other difficulties that impair efficient data entry and command initiation in the PDA. First, the users hand may obscure visibility of a portion of the touch-sensitive display that the user is attempting to touch the stylus to. Second, a speed at which information can be entered using the stylus is impaired by the large motor muscles involved in moving the hand and arm and the overall mass of the arm and hand. Third, as mentioned above, in an environment with a lot of motion (e.g. in a moving vehicle) precision of input is affected as it is difficult to maintain stability between the input hand and the PDA. Fourth, because the stylus is typically removed from a slot or the like in the PDA, the stylus tends to get lost or misplaced by the user. Fifth, because the stylus must be held by the hand of the user, the use of the stylus tends to get in the way of other natural operations while doing information input on the PDA.

As another example, some PDA users load application specific programs on their PDA, such as navigation software. If the PDA is used by a glider pilot to navigate the glider, then the use of a hand held stylus is problematic due to air currents that cause the glider to vibrate and the lack of an extended surface to stabilize the hand and the PDA at the same time. As a result, the glider pilot cannot steady his/her hand to input information or initiate commands using the stylus.

Consequently, there is a need for an ergonomic pointing device that allows a user to input information or initiate commands on a device in a moving environment. There is also a need for an ergonomic pointing device that allows a user to input information or initiate commands on a device without the pointing implement itself or the users hand obscuring visibility of the device. There is also a need for an ergonomic pointing device that allows a user to input information or initiate commands on a device without using the whole hand, that allows the user to establish a reliable position between the device and the hand doing the input, and allows for an increase in a speed at which information can be input on the device. Finally, there is a need for an ergonomic pointing device that is not easily lost or misplaced and can be stowed away so that it does not get in the way of the user when the pointing device is not needed.

### SUMMARY OF THE INVENTION

In view of the foregoing, a brief summary of some of the exemplary embodiments of the present invention are presented in this summary. Some simplifications and omissions may be made in this summary, which is intended to highlight and introduce some aspects of the present invention, but not to limit the scope of the present invention in any way. Detailed descriptions of the preferred embodiments adequate to enable one of ordinary skill in the art to understand, make, and use the present invention are provided following this summary.

Broadly, the present invention is embodied in an ergonomic pointing device that is manipulated by a finger of a user to initiate an action in a device. The action initiated can be any action including but not limited to entering or retrieving information, opening or closing a program or algorithm, selecting an item from a menu of items, dragging and dropping an icon on a display, just to name a few. The ergonomic pointing device includes a holder that is adapted to be mounted on at least a portion of a finger of the users hand and a pointing implement mounted on the holder. With the pointing implement mounted on the holder, the user manipulates the finger to urge the pointing implement into contact with the device to initiate an action in the device. The contact between the pointing implement can include the actuation of a button or switch on the device or touching a desired portion of a touch-sensitive display or a touch-sensitive cursor pad on the device, for example.

The aforementioned need for entering information or initiating an action in a device is met by the ergonomic pointing device of the present invention because the ergonomic pointing device is mounted on a users finger thereby freeing up the users hand for other tasks and allowing the user to steady his/her hand while manipulating the finger to position the ergonomic pointing device to make contact with the device. The same hand having the finger upon which the ergonomic pointing device is mounted can be used to hold the device while the pointing implement initiates actions thereby freeing up the users other hand to perform other tasks. Because the ergonomic pointing device is mounted on the users finger, visibility of the device is not impaired while the users manipulates the finger. The ergonomic pointing device can be movably mounted to the holder or may be removable from the holder such that the ergonomic pointing device can be stowed away when not needed and/or to prevent the ergonomic pointing device from getting in the way of the user. Furthermore, the ergonomic pointing device allows the user to establish a reliable position between the device and the hand manipulating the finger and allows for increased information entry on the device. The ergonomic pointing device of the present invention is well suited to the ergonomic needs of users who must interact with the device in a moving environment, such as an automobile or an aircraft, for example.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a side profile view depicting an ergonomic pointing device with a pointing implement in an engaged position according to the present invention.

FIG. 2 is a side profile view depicting an ergonomic pointing device with a pointing implement in a non-engaged position according to the present invention.

FIGS. 3a through 3d are profile views depicting examples of a pointing implement according to the present invention.

FIG. 4 is a side profile view depicting a holster connected with a holder according to the present invention.

FIG. 5a is a cross-sectional view along line A-A of FIG. 4 and depicts a holster that is removably connected with a holder according to the present invention.

FIG. 5b is a cross-sectional view along line A-A of FIG. 4 and depicts a holster connected with a holder according to the present invention.

FIG. 6a is a side profile view depicting a holster that is removably connected with a holder according to the present invention.

FIG. 6b is a side profile view depicting a holster connected with a holder according to the present invention.

FIGS. 7a and 7b are top and bottom profile views respectively of a holder and a fastener connected with the holder according to the present invention.

FIG. 7c is a side profile view of the holder of FIGS. 7a and 7b and depicts the holder fastened together according to the present invention.

FIG. 8a is a top plan view of a holder with a plurality of slits formed therein for mounting a pointing implement on the holder according to the present invention.

FIG. 8b is a side profile view of a pointing implement mounted on the holder using the slits of FIG. 8a according to the present invention.

FIG. 9 is a side profile view depicting various portions of a finger of a users hand.

FIG. 10 is a side profile view depicting an ergonomic pointing device mounted on one of the portions of the finger depicted in FIG. 9.

FIG. 11 is a profile view of a pointing implement including a pin and an o-ring thereon according to the present invention.

FIG. 12 is a side profile view of a holster with a groove therein adapted to receive the pin depicted in FIG. 11 and to position the pointing implement in an engaged position according to the present invention.

FIG. 13 is a side profile view of a holster with a groove therein adapted to receive the pin depicted in FIG. 11 and to position the pointing implement in a non-engaged position according to the present invention.

FIGS. 14a and 14b are profile views of alternative embodiments of a holder and a holster according to the present invention.

FIG. 15a is a cross-sectional view of a holster including a resistance element according to the present invention.

FIGS. 15b and 15c are cross-sectional views of a pointing implement inserted in the holster of FIG. 15a.

FIG. 16 is a side profile view of an alternative embodiment of an ergonomic pointing device according to the present invention.

FIG. 17 is a side profile view of an alternative embodiment of an ergonomic pointing device according to the present invention.

FIG. 18 is a side profile view of an alternative embodiment of an ergonomic pointing device according to the present invention.

FIGS. 19a and 19b are a profile view and a cross-sectional view respectively of a pointing implement including an aperture therein according to the present invention.

FIGS. 20a and 20b depict a holster including pins and the pointing implement of FIG. 19b mounted in the holster according to the present invention.

### DETAILED DESCRIPTION

In the following detailed description and in the several figures of the drawings, like elements are identified with like reference numerals.

As shown in the drawings for purpose of illustration, the present invention is embodied in an ergonomic pointing device. The ergonomic pointing device is manipulated by a finger of a user to initiate an action in a device. The ergonomic pointing device includes a holder that is adapted to be mounted on at least a portion of the users finger and a pointing implement mounted on the holder. The pointing implement can be mounted on the holder using a wide variety of means as will be discussed below. With the pointing implement mounted on the holder, the user manipulates the finger that the holder is mounted on to urge the pointing implement into contact with the device to initiate the action in the device.

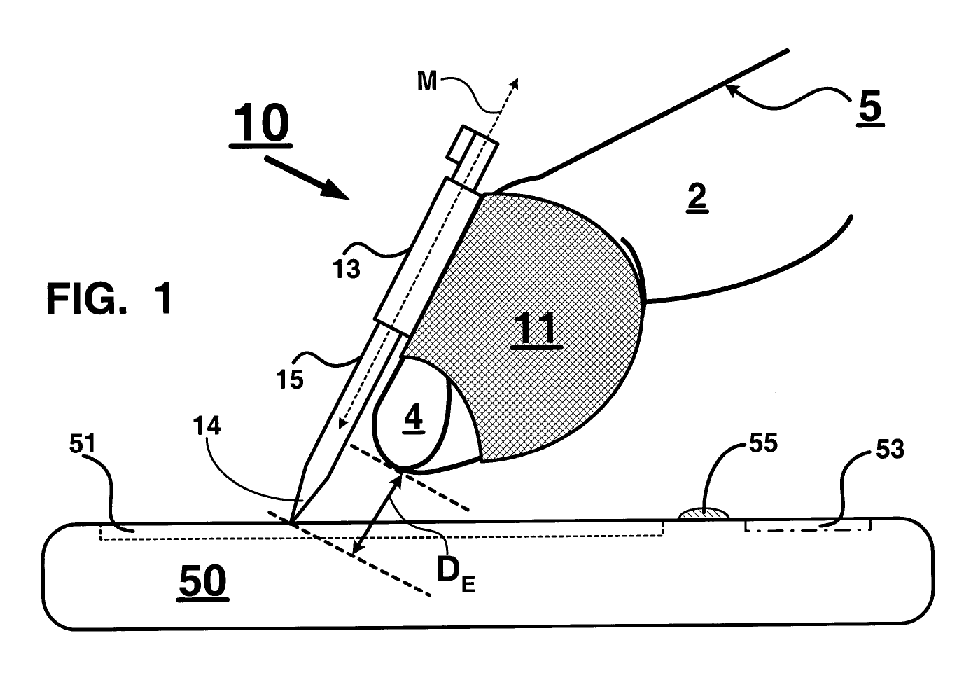

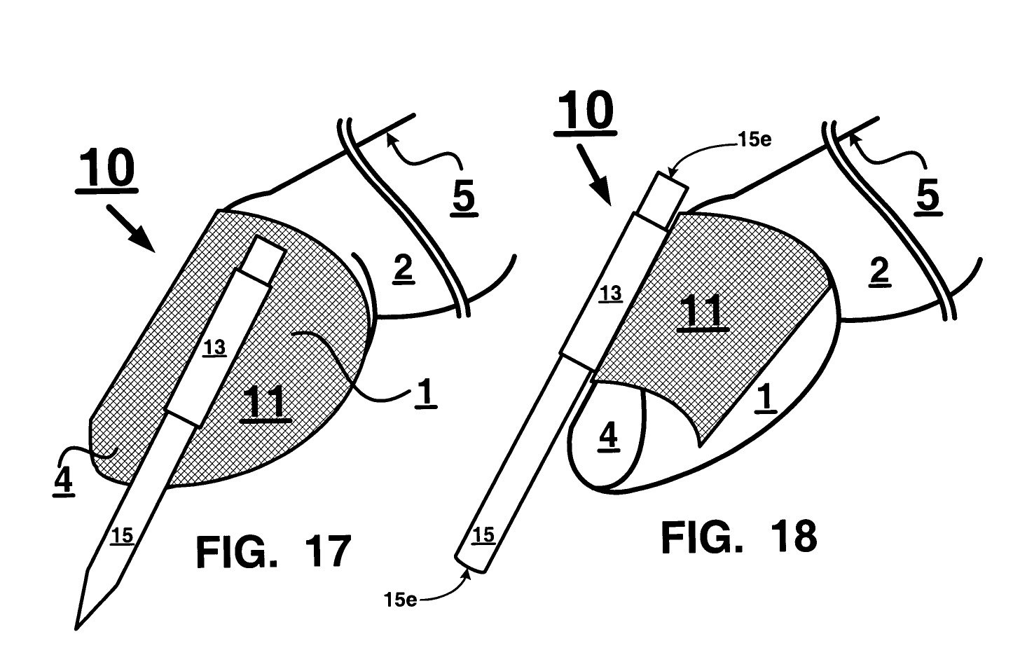

In FIG. 1, an ergonomic pointing device 10 includes a holder 11 mounted on a portion of a finger 5, a holster 13 connected with the holder 11, and a pointing implement 15. The holster 13 is adapted to receive the pointing implement 15 so that the pointing implement 15 is mounted on the holder 11. The ergonomic pointing device 10 can be mounted on any finger 5 on a users hand. For example, the ergonomic pointing device 10 can be mounted on an index finger of the users hand. After mounting the pointing implement 15 on the holder 11, the user (not shown) manipulates the finger 5 to urge the pointing implement 15 into contact with a device 50 to initiate an action in the device 50. The pointing implement 15 can include an end portion 14 that tapers to a point (e.g. to a tip or the like). For example, if the pointing implement 15 is a writing implement, such as a pen or a pencil, then the end portion 14 can be the lead of the pencil or the tip of the pen. The pointing implement 15 need not terminate at a tip and can include an end 15e that is blunt, flat, or rounded (see 15e in FIG. 18). In FIG. 1, the end portion 14 of the pointing implement 15 is urged into contact with the device 50 to initiate the action. An advantage to the end point 14 is that it allows for a more accurate contact with the device 50 due to a smaller contact area of the end point 14.

The action initiated by the contact of the pointing implement 15 with the device 50 can be any action that can be initiated by a contact. Examples of the actions that can be initiated include but are not limited to: entering or retrieving information; opening or closing a program or algorithm; selecting an item from a menu; dragging and dropping an object on a display; moving a cursor on a display; selecting ASCII characters from an image of a QWERTY keyboard displayed on a touch-sensitive display; scrolling a display; highlighting text or other objects on a display; selecting an object on a display; cut and paste operations; actuating a button or a switch resulting in some action being initiated; actuating a joy stick switch; and manipulating cursor control switches or track balls. The device 50 need not be an electrical device.

The pointing implement 15 can be urged into contact with a component carried by the device 50. The component can include but is not limited to a touch-sensitive display 51, a touch-sensitive cursor pad 53, and a switch 55. In FIG. 1, the end portion 14 of the pointing implement 15 is urged into contact with the touch-sensitive display 51, such as the type carried by a PDA, a cell phone, or a TPC, for example. The pointing implement 15 can be used in lieu of a stylus or other pointing device that is customarily used to initiate actions or commands on the device 50. For example, if the device 50 is a PDA that includes a stylus carried by the PDA, then the pointing implement 15 can be used in the same manner as the stylus. In instances where the finger 5 of the users hand can be used to initiate actions or commands on the device 50, then the pointing implement 15 can be used in the same manner as the finger 5, with the added advantage of greater precision in initiating actions due to the smaller footprint of the pointing implement 15, particularly when the end portion 14 is used to contact the device 50. Because the pointing implement 15 extends beyond the finger tip 4 (as will be described below) it extends the reach of the users hand. As another example, in FIG. 1, the pointing implement 15 can be urged into contact with a switch 55 carried by the device 50 in order to initiate an action in the device 50. If the device 50 is a PDA or a TPC, then the button 55 can be a cursor control button that moves a cursor displayed on the display 51 up, down, left, right, etc. The switch 55 can be any type of switch including but not limited to a button, a joy stick, a track ball, a scrolling wheel, just to name a few.

In FIGS. 1 and 2, the pointing implement 15 can be movable M in the holster 13. Alternatively, in FIG. 8b, the pointing implement 15 can be movable M in the holder 11. Advantages of moving M the pointing implement 15 (i.e. the pointing implement 15 can be moved back and forth along an axis M) include the ability to adjust a distance D_{E} the pointing implement 15 extends beyond a finger tip 4 of the finger 5 in order to effectuate the contact with the device 50. Conversely, the pointing implement 15 can be movable M in the holster 13 or holder 11, to retract the pointing implement 15 behind the finger tip 4 by a distance D_{R} (see FIG. 2). Accordingly, the movement M accommodates the ergonomic needs of different users by allowing for adjustability of the pointing implement 15 relative to the finger 5. Another advantage to retracting the pointing implement 15 is that it allows the pointing implement 15 to be stowed away so that it does not get in the way of the user when the ergonomic pointing device 10 is not needed.

The pointing implement 15 can be movable M on the holster 13 or the holder 11 between an engaged position (see FIG. 1) where the pointing implement 15 is positioned to make the contact with the device 50 (i.e. because it is extended beyond the finger tip 4) and a non-engaged position (see FIG. 2) where the pointing implement 15 is not positioned to make the contact with the device 50 (i.e. because it is retracted behind the finger tip 4).

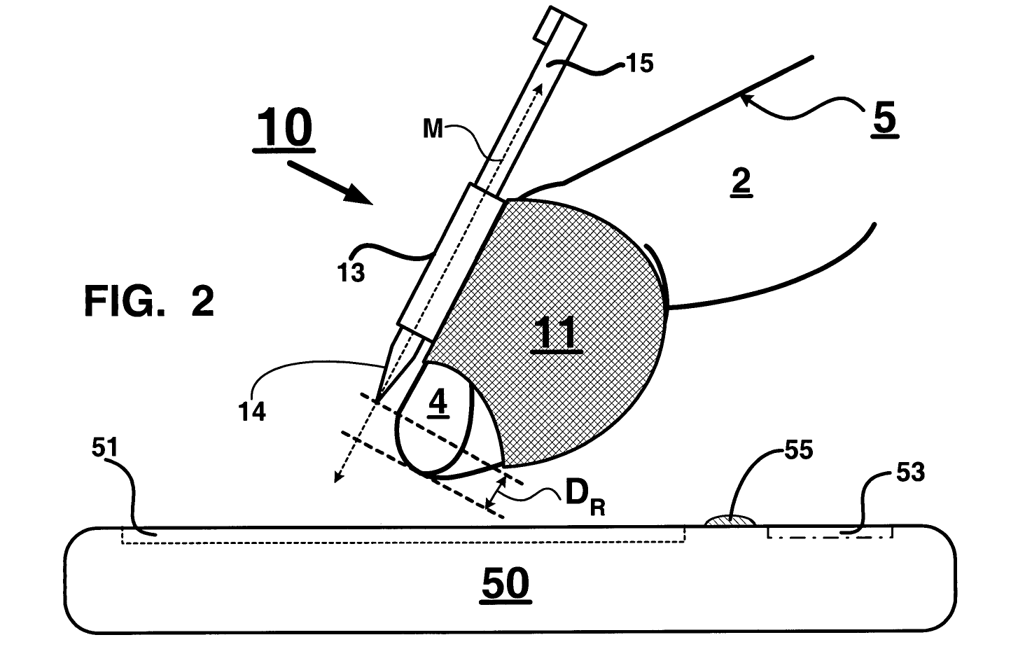

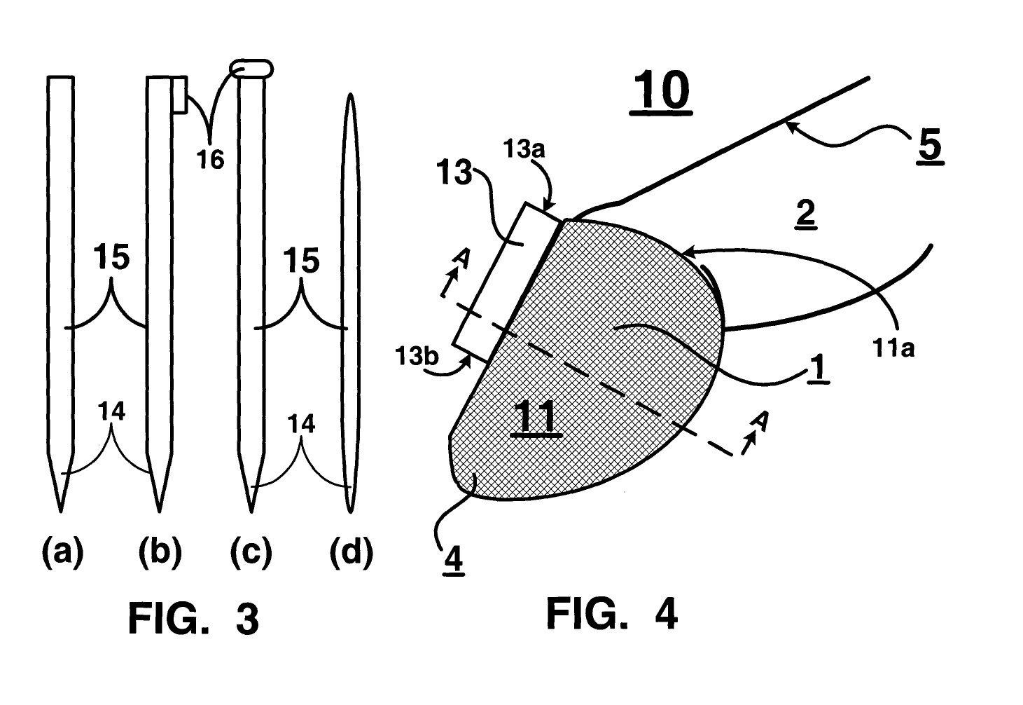

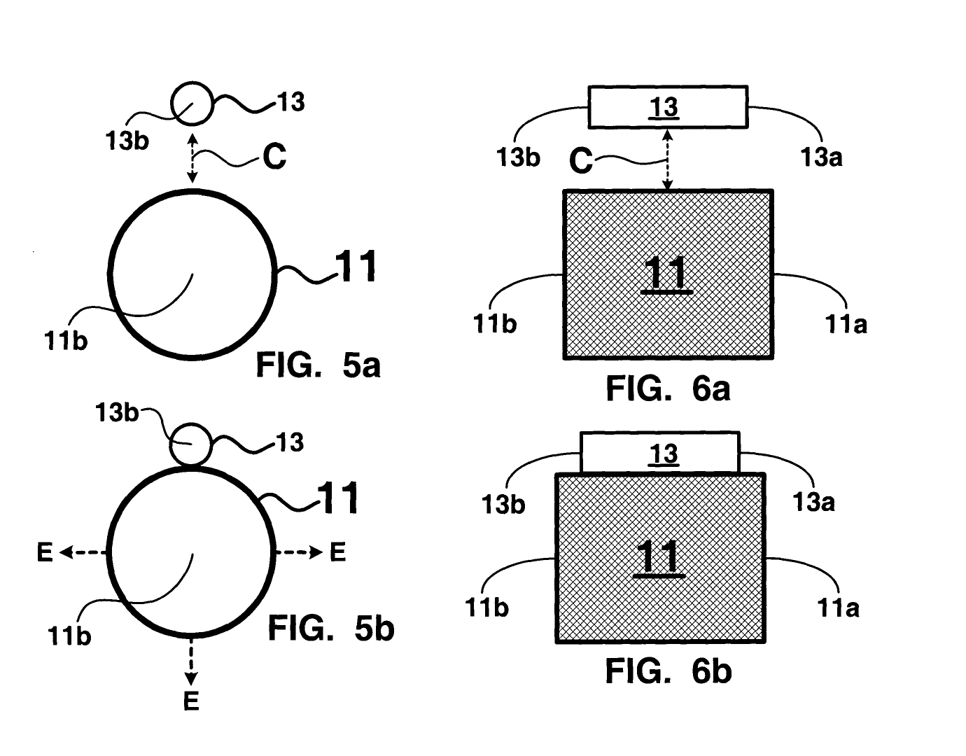

In FIGS. 3a through 3d, the pointing implement 15 can be any implement including but not limited to a stylus (see FIGS. 3b and 3c), a writing implement, such as a pencil or a pen (see FIG. 3a), and a tooth pick (see FIG. 3d). As another example, the pointing implement 15 can be a nail (e.g. like the type used with a hammer), a needle, or a pin (e.g. like the type used for clothing and fabrics). The stylus includes but is not limited to the type of stylus used for a PDA, a TPC, or for use on a touch-sensitive display or touch sensitive cursor pad. Although the pointing implement 15 and the holster 13 are depicted as having a circular cross-sectional profile (see FIGS. 5a, 5b, 20a, and 20c) the pointing implement 15 and the holster 13 are not limited to the cross-sectional profiles depicted herein. Preferably, the pointing implement 15 and the holster 13 have cross-sectional profiles that complement each other. For instance, the pointing implement 15 and the holster 13 can have a rectangular, a square, an oval, an arcuate, or a triangular cross-sectional profile.

The pointing implement 15 can be mounted on the holder 11 in a variety of ways. In FIGS. 1, 2, 5a, 5b, 6a, and 6b, the pointing implement 15 is mounted to the holder 11 using a holster 13 that is connected with the holder 11. The holster 13 is adapted to receive the pointing implement 15. For example, if the pointing implement 15 is a stylus with a cylindrical cross-section, then the holster 13 can be a tube with a sufficient inside diameter to accommodate an outside diameter of the pointing implement 15. The holster 13 can be permanently connected (i.e. fixedly connected) with the holder 11 (see FIGS. 5b and 6b). The holster 13 can be fixedly connected with the holder 11 using a variety of methods including but not limited to fasteners such as adhesives, glue, welds, thread (i.e. sewn on), a screw, and a nut and bolt.

Alternatively, the holster 13 can be removably connected with the holder 11 (see dashed arrow C in FIGS. 5a and 6a). Methods for removably connecting the holster 13 with the holder 11 include but are not limited to fasteners such as VELCRO®, a snap, a clip, a button, and a magnet. Advantages to removably connecting the holster 13 with the holder 11 include instances where either one or both of the holder 11 and/or the holster 13 is disposable and it is desirable to retain the non-disposable portion (11 or 13). For example, if the holder 11 is disposable, then the holster 13 is retained for attachment to a new holder 11. Obviously, the pointing implement 15 can also be retained or the pointing implement 15 can be disposable as well.

For some uses, it may be desirable to use the ergonomic pointing device 10 in a clean room environment or in a medical environment (e.g. treating patients or for surgery). Accordingly, to prevent particulate or chemical contamination in a clean room, the ergonomic pointing device 10 can be disposable by the user or a portion of the ergonomic pointing device 10 can be disposable (e.g. the holder 11) and another portion can be recyclable (e.g. the holster 13 and/or the pointing implement 15).

For uses in a medical or laboratory environment where there is a risk of cross-contamination, spread of disease, and infection, the ergonomic pointing device 10 can be sterilized prior to any use. Following the procedure, the ergonomic pointing device 10 can be destroyed or disposed of. Alternatively, only a portion of the ergonomic pointing device 10 (e.g. 11, 13, or 15) is destroyed or disposed of and a remaining portion can be recycled and re-sterilized for a future use. Optionally, the ergonomic pointing device 10 can be sterilized. After the sterilization, the ergonomic pointing device 10 can be placed in a package (e.g. in a sealed container) that protects the ergonomic pointing device 10 from contamination so that the ergonomic pointing device 10 is ready for use in a future procedure. The ergonomic pointing device 10 is useful in medical procedures, such as surgery, where equipment used to monitor a patients vital signs or used to operate apparatus used for the surgery includes a touch-sensitive display interface or otherwise must by contacted by the surgeon or staff to initiate an action in the equipment.

The holder 11 can be made from a fabric or other type of flexible material. An adhesive can be applied to the holder 11 so that the holder is mounted on the finger 5 in a manner similar to an adhesive bandage, such as a band aid, for example (see 11 in FIG. 18). After a use in a medical procedure, a clean room environment, or some other procedure, the holder 11 can be peeled off of the finger 5 and then disposed of. Alternatively, if is desirable to recycle any portion of the ergonomic pointing device 10 (e.g. 11, 13, or 15), then a material such as stainless steel, a surgical grade metal, or other suitable material can be used for the ergonomic pointing device 10 or any portion thereof.

In FIGS. 8a and 8b, the pointing implement 15 can be removably mounted with the holder 11. Similarly, in FIGS. 1, 2, and 4, if the pointing implement 15 is mounted with the holder 11 using the holster 13, then the pointing implement 15 can be removable from the holster 13. The holster 13 can include a through hole terminating at two apertures 13a and 13b and the pointing implement 15 can be inserted into and removed from the holster 13 via the apertures (13a, 13b). In either case, advantages to removing the pointing implement 15 from the holder 11 or the holster 13 include replacing the pointing implement 15 if it is lost or misplaced, or changing a style or a type of the pointing implement 15 used (e.g. substituting a tooth pick for a stylus).

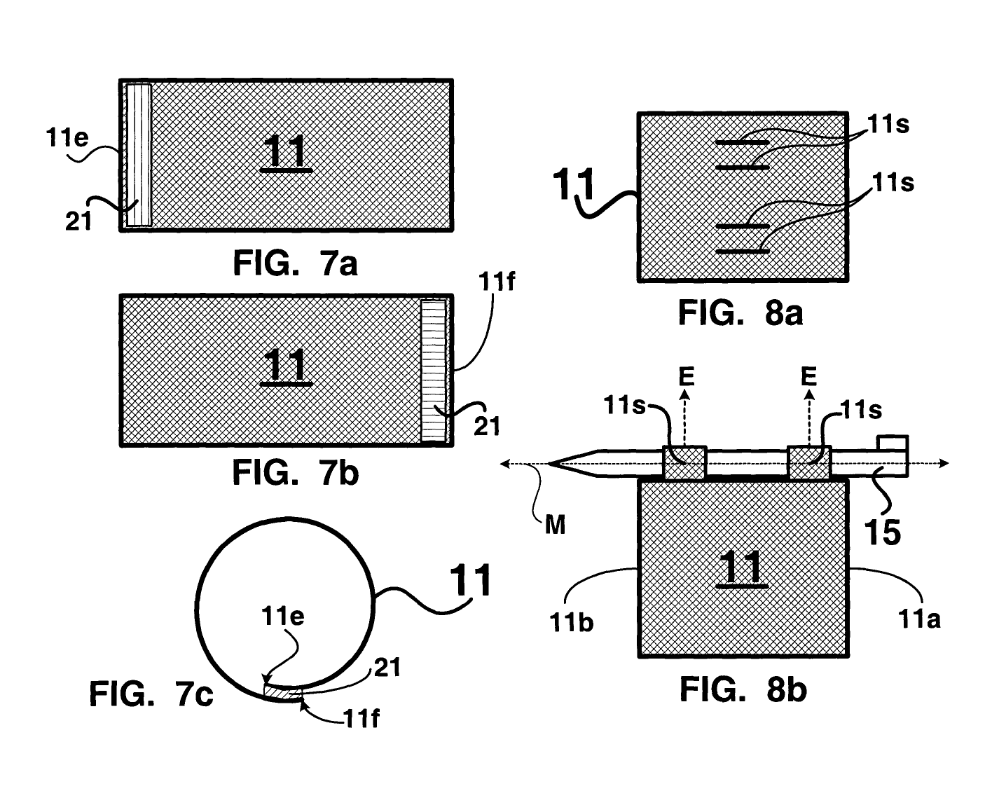

In FIGS. 1, 2, and 4 through 8b, the holder 11 can be in the shape of a sleeve and the holder 11 is mounted on the users finger 5 by inserting the finger 5 through the sleeve. The finger 5 can be inserted through an open end (11a, 11b) of the holder 11 (see FIGS. 6a and 6b). In FIGS. 7a and 7b, the holder 11 can be a piece of material such as a fabric (e.g. natural or synthetic) or an elastic material. A fastener 21 is connected with the holder 11 on opposite sides of opposed ends of the holder 11. For example, VELCRO® can be used for the fastener 21. In FIG. 7c, the holder 11 is folded over so that the fasteners 21 engage each other to form the sleeve. One of the open ends (11a, 11b) can be closed so that the holder 11 has the shape of a finger cot (see FIG. 4) and the finger 5 is inserted in the end that is not closed. The holder 11 need not have a cylindrical shape as depicted in FIGS. 6a, 6b, and 7c.

In FIG. 8a, the holder 11 can include a plurality of slits 11s formed in the holder 11. For example, a knife, scissor, or laser can be used to cut the slits 11s. The holder 11 can be made from a fabric or an elastic material so that the slits 11s can expand to receive the pointing implement 15 as depicted in FIG. 8b. The slits 11s can also allow the pointing implement 15 to be movable M on the holder 11 and allow for the pointing implement 15 to be removable from the holder 11. The embodiment of FIGS. 7a through 7c can include the slits 11 s or can include the holster 13 as depicted in FIGS. 5a through 6b.

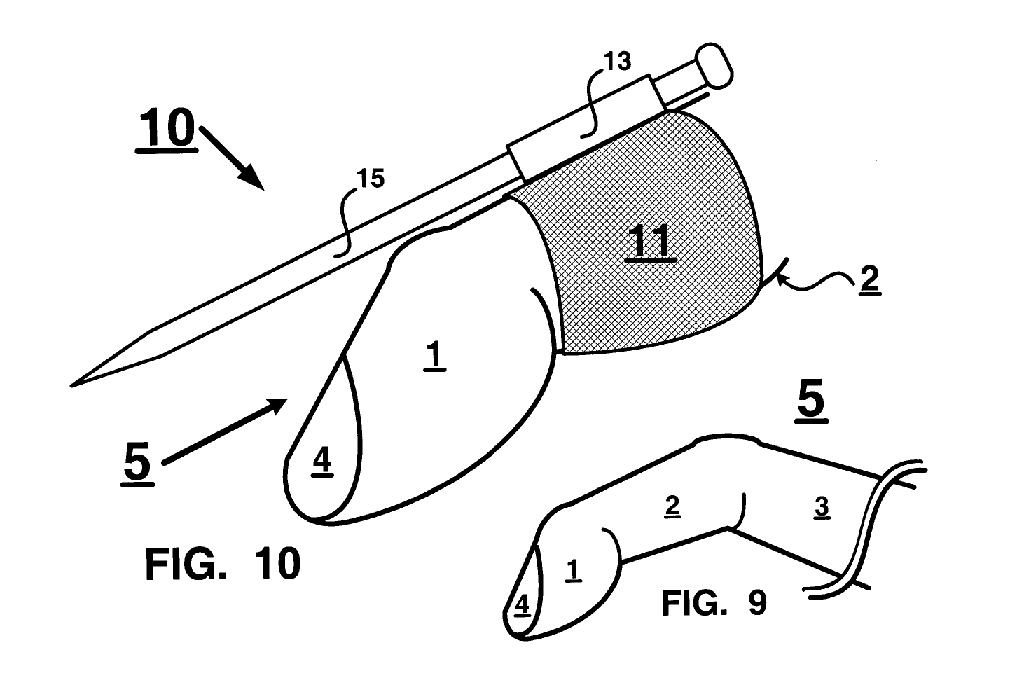

The holder 11 can be mounted on at least a portion of the finger 5 on the users hand (not shown). In FIG. 9, the finger 5 is depicted with three sections (1, 2, 3, and 4). In FIG. 10, the holder 11 is mounted on at least a portion of section 2. In FIGS. 1 and 2, the holder 11 is mounted on at least a portion of section 1. In FIG. 4, the holder 11 is mounted on all of section 4 (i.e. the finger nail) and on at least a portion of section 1 (i.e. the tip of the finger 5) such that the holder 11 has the shape of a finger cot. Although not shown, the holder 11 can also be mounted on at least a portion of section 3 of FIG. 9.

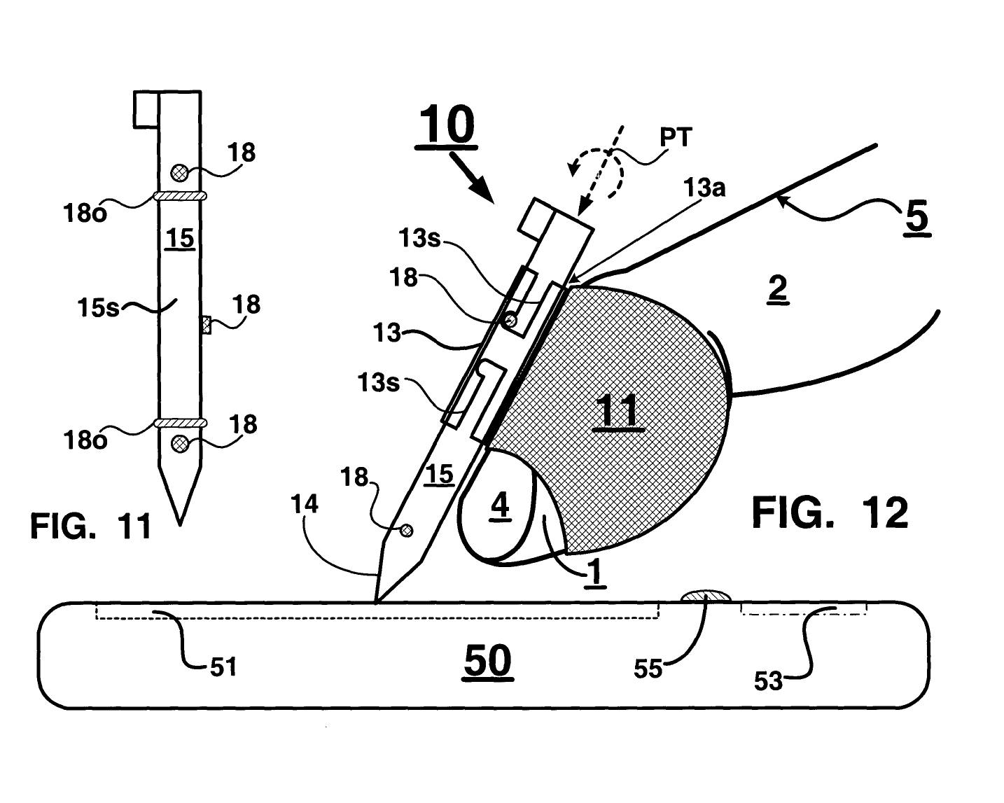

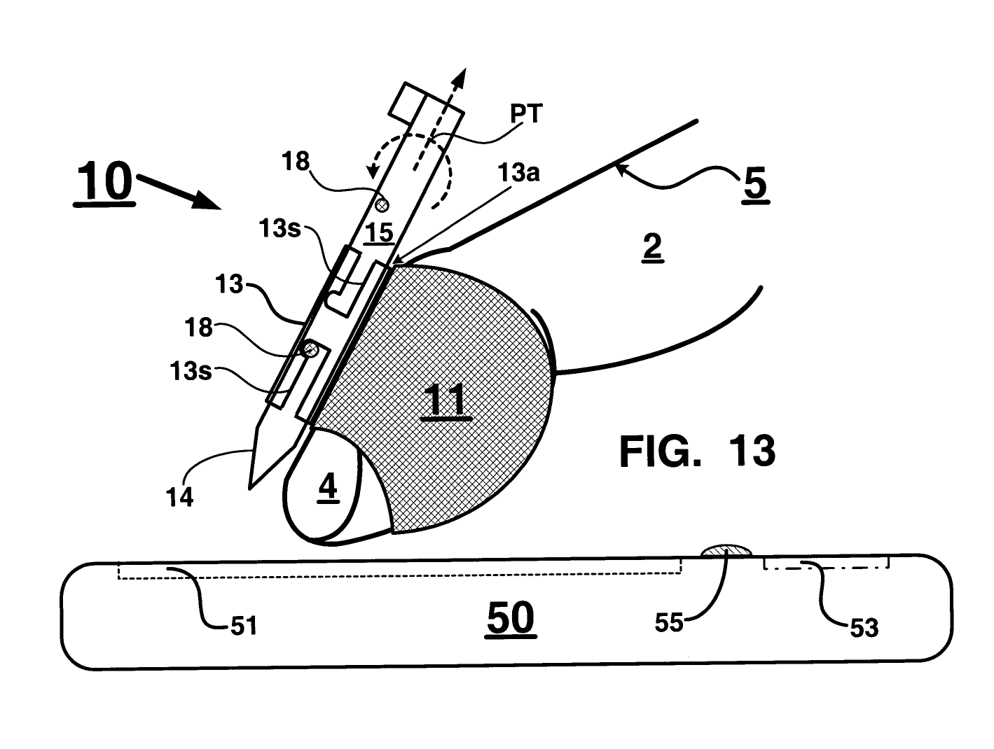

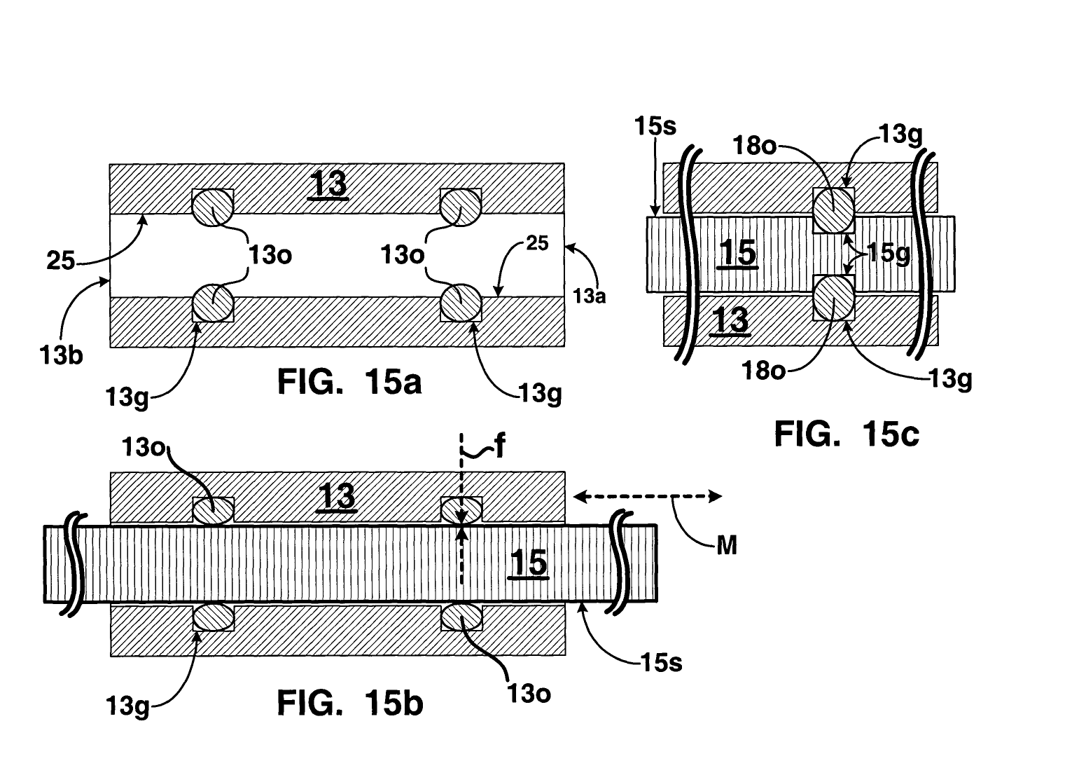

In FIG. 11, the pointing implement 15 can include at least one pin 18 (three are shown) that extends outward of a surface 15s of the pointing implement 15. In FIGS. 12 and 13, the holster 13 can include at least one slot 13s adapted to receive the pin 18 when the pointing implement 15 is inserted into the holster 13. Alternatively, as will be described below in reference to FIG. 15c, the pointing implement 15 can also include at least one o-ring 18o connected with the pointing implement 15. The o-ring 18o can be seated in a groove 15g (not shown) or it can be connected with the surface 15s.

In FIG. 12, the pointing implement 15 is inserted through the aperture 13a and then pin 18 is aligned with the slot 13s followed by twisting the pointing implement 15 to lock the pin 18 in the slot 13s as depicted by the dashed arrows PT. As a result, the pointing implement 15 is locked in the engaged position as was described above in reference to FIG. 1.

In FIG. 13, pointing implement 15 is pulled backward towards the aperture 13a and the pin 18 (i.e. the pin 18 nearest the end portion 14) is aligned with the slot 13s followed by twisting the pointing implement 15 to lock the pin 18 in the slot 13s as depicted by the dashed arrows PT. Consequently, the pointing implement 15 is locked in the non-engaged position as was described above in reference to FIG. 2.

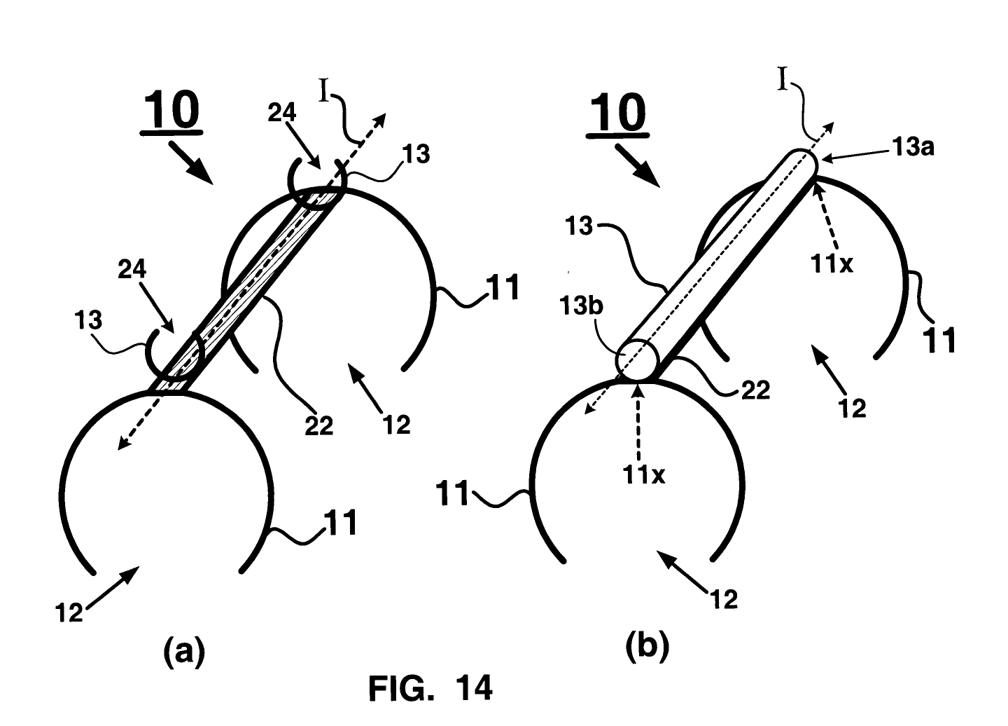

In FIG. 14a, in an alternative embodiment of the ergonomic pointing device 10, one or more rings (two are shown) are used to form the holder 11. The rings may include an opening 12 that allows the holder 11 to be inserted over a portion of the finger 5. On the other hand, the rings can be totally enclosed so that the holder 11 is slipped onto the finger 5 in a manner similar to a jewelry ring. A bridge 22 connects the rings of the holder 11. Similarly, one or more rings (two are shown) can be used to form the holster 13. The holster 13 can be connected with the bridge 22. The holster 13 may include an opening 24 that allows the pointing implement 15 to be inserted into the holster 13 through the opening 24. The holster 13 may also be totally enclosed and the pointing implement 15 is inserted along an axis I into the holster 13 to mount the pointing implement 15 with the holder 11. The holder 11 and the holster 13 can be made from a material that is flexible to allow the holder 11 to be inserted over the finger 5 through the openings 12 and to allow the pointing implement 15 to be inserted along the axis I into the holster 13 through the openings 24.

In FIG. 14b, the bridge 22 connects the rings of the holder 11 and the holster 13 is a tube connected with the bridge 22. The pointing implement 15 is inserted along an axis I into the holster 13 through one of the apertures (13a, 13b). Alternatively, the bridge 22 can be eliminated entirely and the tube for the holster 13 can be directly connected with the holder 11 (see arrow 11x) such that the tube forms a bridge or spine between the rings of the holder 11.

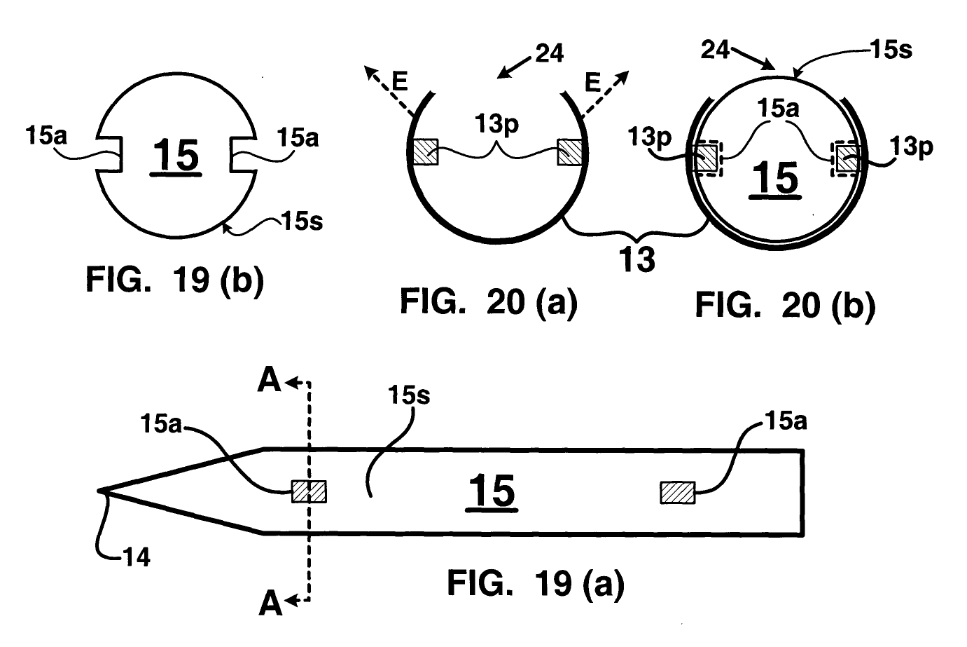

In FIGS. 19a and 19b, the pointing implement 15 can include an aperture 15a (two are shown) formed in the outer surface 15s of the pointing implement 15. In FIG. 20a, the rings of FIG. 14a that define the holster 13 can include a pin 13p that has a profile that complements a profile of the aperture 15a. The holster 13 can be made from a flexible material that allows the holster 13 to expand E to accept the pointing implement 15 through the opening 24.

In FIG. 20b, the pointing implement 15 is depicted mounted in the holster 13 with the pins 13p inserted into the apertures 15a (see dashed lines for 15a). Accordingly, the pointing implement 15 is movable M between the extended and non-extended positions as described above in reference to FIGS. 12 and 13. The pins 13p and the apertures 15a can also be used to lock the pointing implement 15 in a user preferred position in the holster 13.

It may be desirable for the pointing implement 15 to be movable M in the holster 13 and yet have the pointing implement 15 retain an arbitrary position (i.e. a position selected by the user) in the holster 13 until the user decides to move the pointing implement 15 to a new position in the holster 13. To that end, the holster 13 and/or the pointing implement 15 can include a resistance element that prevents inadvertent movement of the pointing implement 15 in the holster 13. In FIG. 15a, an example of a resistance element includes a circumferential grove 13g formed in an interior surface 25 of the holster 13. At least one o-ring 13o is positioned in the groove 13g. An inside diameter of the holster 13 proximate the o-rings 13o is less than an outside diameter of the pointing implement 15.

In FIG. 15b, when the pointing implement 15 is inserted into the holster 13, the o-rings 13o contacts an outside surface 15s of the pointing implement 15 and compresses the o-rings 13o resulting in a pressure force and/or friction force F acting on the pointing implement 15 to prevent inadvertent movement of the pointing implement 15 in the holster 13. Alternatively, the interior surface 25 of the holster 13 can be coated with a friction producing material such as a rubber or a silicone elastomer material that resists movement of the pointing implement 15 in the holster 13. On the other hand, the outside surface 15s of the pointing implement 15 can be coated with a friction producing material such as a rubber or a silicone elastomer material to accomplish the same result.

On the other hand, the resistance element can be connected with the pointing implement 15 as depicted in FIGS. 11 and 15c, wherein the pointing implement 15 includes at least one o-ring 18o. The o-ring 18o can be positioned in a groove 15g formed in the pointing implement 15 (see FIG. 15c) or the o-ring 18ocan be connected with the outer surface 15s (see FIG. 11). For example, the o-ring 18o can be connected with the outer surface 15s using an adhesive or a glue. Preferably, the groove 15g is used to prevent the o-ring 18o from moving or slipping off of the pointing implement 15 when it is inserted into or removed from the holster 13.

In FIG. 15c, with the pointing implement 15 inserted into the holster 13, the o-ring 18o engages the groove 13g to prevent inadvertent movement of the pointing implement 15 in the holster 13. Furthermore, the resistance element can be used to position the pointing implement 15 in the engaged and non-engaged positions as described above or to lock the pointing implement 15 in a user preferred position in the holster 13. Alternatively, the groove 13g can be eliminated and the o-ring 18o can be appropriately sized so that when the pointing implement 15 is inserted into the holster 13 the o-ring 18o compresses and generates a sufficient pressure force and/or friction force F that acts on the pointing implement 15 to prevent inadvertent movement of the pointing implement 15 in the holster 13.

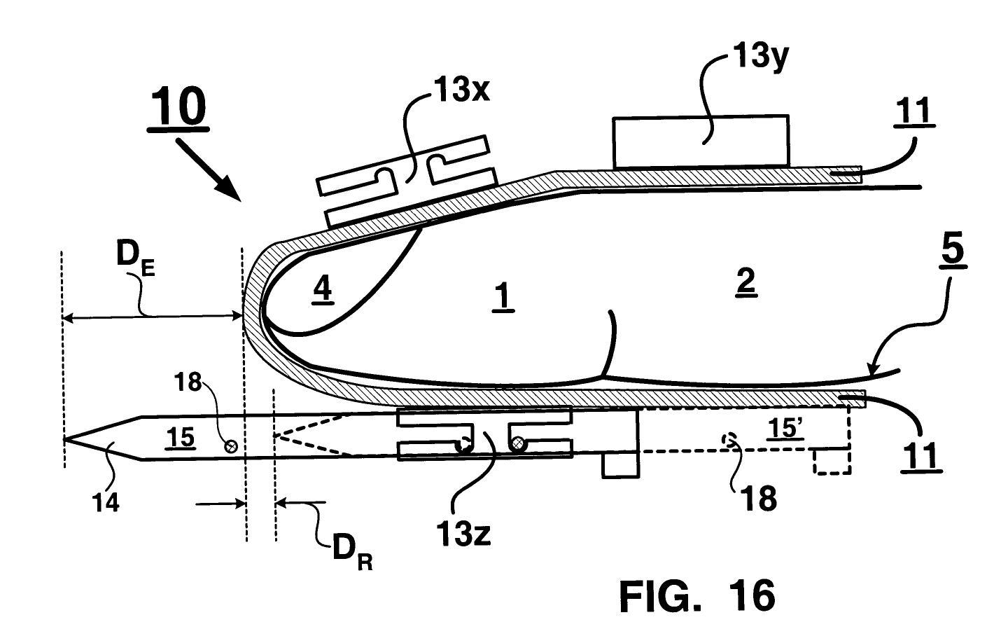

In FIG. 16, the ergonomic pointing device 10 can include a holder 11 shaped like a finger splint such that the holder 11 is slipped onto the finger 5. The pointing implement 15 can be directly mounted to the holder 11 or a holster 13 can be connected with the holder 11. The holster 13 can be positioned on the holder 11 in various configurations including holsters (13x, 13y) on a top portion of the holder 11 and holster 13z on a bottom portion of the holder 11.

The material selected for the holder 11 can be selected so that the material is malleable or flexible so that the holder 11 can be bent and shaped to conform to a profile of the users finger 5. As an example, a light weight material such as aluminum (Al) can be used for the holder 11 and for the holster 13. The holster 13 can include the slots 13s so that the pointing implement 15 can be locked into the engaged position (see solid lines for 15) and the non-engaged position (see dashed lines for 15′). Uses for the embodiment depicted in FIG. 16 are not to be construed as being limited to a medical procedures or for medical uses only. The finger splint of FIG. 16 is only one example of how the holder 11 can be implemented.

In FIG. 17, the holster 13 can be connected with the holder 11 anywhere on the holder 11 including but not limited to a side portion of the holder 11 so that when the holder 11 is mounted on the users finger 5, the holster 13 is positioned on a side of the users finger 5. The splint of FIG. 16 can also be configured so that the holster 13 is positioned on a side of the finger 5 when the holder is mounted on the users finger 5 as opposed to the top or the bottom of the finger 5. If the holster 13 is not used, then the pointing implement 15 can be mounted anywhere on the holder 11 including but not limited to a side portion of the holder 11 so that when the holder 11 is mounted on the users finger 5, the pointing implement 15 is positioned on a side of the users finger 5.

The holder 11 need not be mounted along an entirety of a circumference of the users finger 5 as depicted in FIGS. 10 and 12 where the portion 2 or the portion 1 respectively are entirely wrapped by the holder 11. Alternatively, the holder 11 can be mounted on less than the entire circumference of the users finger 5 as depicted in FIG. 18 where the portion 1 is not entirely wrapped by the holder 11 so that some of the portion 1 is not covered by the holder 11. An adhesive can be applied to the holder 11 of FIG. 18 to effectuate the mounting the holder 11 on less than the entire circumference of the users finger 5. For example, the holder 11 in FIG. 8b can be mounted on the finger 5 and then rotated on the finger 5 to position the pointing implement 15 on a top, bottom, or side of the finger 5, or anywhere in between.

For the embodiments described herein, the pointing implement 15 and the holster 13 can be made from a variety of materials including but not limited to metals, plastics, glass, ceramics, composite materials, wood, and rubber. The holder 11 can be made from a variety of materials including but not limited to metals, plastics, wood, nylon, rubber, a silicone elastomer material, ceramics, a composite material, and natural or synthetic fabrics or fibers.

Although several embodiments of the present invention have been disclosed and illustrated, the invention is not limited to the specific forms or arrangements of parts so described and illustrated. The invention is only limited by the claims.

1. An ergonomic pointing device manipulated by a finger of a user to initiate an action in a device, comprising:
a holder adapted to be mounted on at least a portion of the finger of the user;
a pointing implement; and
a means connected with the holder for mounting the pointing implement on the holder,
wherein the user manipulates the finger to urge the pointing implement into contact with the device to initiate the action.

2. The ergonomic pointing device as set forth in claim 1, wherein the pointing implement further includes an end portion that tapers to a point and the user manipulates the finger to urge the end portion of the pointing implement into contact with the device to initiate the action.

3. The ergonomic pointing device as set forth in claim 1, wherein the pointing implement comprises an implement selected from the group consisting of a stylus, a writing implement, a needle, a pin, a nail, and a tooth pick.

4. The ergonomic pointing device as set forth in claim 1, wherein the pointing implement is urged into contact with a component carried by the device and the component is selected from the group consisting of a touch-sensitive display, a touch-sensitive cursor pad, and a switch.

5. The ergonomic pointing device as set forth in claim 1, wherein the pointing implement is a selected one of fixedly mounted on the holder or removably mounted on the holder.

6. The ergonomic pointing device as set forth in claim 1, wherein the pointing implement is movable in the holder.

7. The ergonomic pointing device as set forth in claim 1, wherein the pointing implement is movable on the holder between an engaged position wherein the pointing implement is positioned to make the contact with the device to initiate the action and a non-engaged position wherein the pointing implement is not positioned to make the contact with the device.

8. The ergonomic pointing device as set forth in claim 1, wherein the holder comprises a sleeve and the holder is mounted to the finger by inserting the finger through the sleeve.

9. The ergonomic pointing device as set forth in claim 1, wherein a selected one or more of the holder, the pointing implement, or the means connected with the holder is disposable.

10. The ergonomic pointing device as set forth in claim 1, wherein a selected one or more of the holder, the pointing implement, or the means connected with the holder is recyclable.

11. The ergonomic pointing device as set forth in claim 1, wherein the ergonomic pointing device is sterilized.

12. The ergonomic pointing device as set forth in claim 1, wherein the holder is mounted on the finger using an adhesive connected with the holder.

13. The ergonomic pointing device as set forth in claim 1, wherein the holder is a component selected from the group consisting of a finger cot and a finger splint.

14. The ergonomic pointing device as set forth in claim 1, wherein the means for mounting the pointing implement to the holder comprises a holster connected with the holder and adapted to receive the pointing implement.

15. The ergonomic pointing device as set forth in claim 14, wherein the holster is a selected one of fixedly connected with the holder or removably connected with the holder.

16. The ergonomic pointing device as set forth in claim 15, wherein the holster is fixedly connected with the holder using a fastener selected from the group consisting of an adhesive, a glue, a weld, a thread, a screw, and a nut and bolt.

17. The ergonomic pointing device as set forth in claim 15, wherein the holster is removably connected with the holder using a fastener selected from the group consisting of VELCRO, a snap, a button, a clip, and a magnet.

18. The ergonomic pointing device as set forth in claim 14, wherein the pointing implement is movable in the holster between an engaged position wherein the pointing implement is positioned to make the contact with the device to initiate the action and a non-engaged position wherein the pointing implement is not positioned to make the contact with the device.

19. The ergonomic pointing device as set forth in claim 14, wherein the pointing implement is a selected one of fixedly connected with the holster or removably connected with the holster.

20. The ergonomic pointing device as set forth in claim 14, wherein the holster further includes a resistance element in contact with the holster and the pointing implement and operative to retain the pointing implement in an arbitrary position in the holster until the user moves the pointing implement to a new position in the holster.

21. The ergonomic pointing device as set forth in claim 14, wherein the pointing implement further includes a resistance element in contact with the pointing implement and the holster and operative to retain the pointing implement in an arbitrary position in the holster until the user moves the pointing implement to a new position in the holster.

22. The ergonomic pointing device as set forth in claim 14 and further comprising:
a means for locking the pointing implement in a user preferred position in the holster.

23. The ergonomic pointing device as set forth in claim 14, wherein a selected one or more of the holder, the pointing implement, or the holster is disposable.

24. The ergonomic pointing device as set forth in claim 14, wherein a selected one or more of the holder, the pointing implement, or the holster is recyclable.

25. The ergonomic pointing device as set forth in claim 14, wherein the holder is mounted on the finger using an adhesive connected with the holder.

26. The ergonomic pointing device as set forth in claim 14, wherein the ergonomic pointing device is sterilized.

27. The ergonomic pointing device as set forth in claim 14, wherein the pointing implement is movable in the holster.
